(19) United States
(12) Patent Application Publication
(10) Pub. No.: US 2013/0048601 A1
(43) Pub. Date: Feb. 28, 2013

(54) Use of Hydrogen-Oxygen Plasma for Forming Hydroxyl Functional Groups on a Polymer Surface

(71) Applicants: Paul Dryer, Lexington, KY (US); David Bernard, Lexington, KY (US); David Rhine, Georgetown, KY (US); Xiaoming Wu, Lexington, KY (US); Jing X. Sun, Lexington, KY (US); Gary Williams, Paris, KY (US)

(72) Inventors: Paul Dryer, Lexington, KY (US); David Bernard, Lexington, KY (US); David Rhine, Georgetown, KY (US); Xiaoming Wu, Lexington, KY (US); Jing X. Sun, Lexington, KY (US); Gary Williams, Paris, KY (US)

(21) Appl. No.: 13/222,120

(22) Filed: Aug. 31, 2011

(51) Int. Cl. B05D 3/04; B44C 1/22

(52) U.S. Cl. 216/34; 427/536

(57) ABSTRACT

A method for improving adhesion between polymeric materials is provided. The method includes treating a surface of a first polymeric material with plasma of oxygen gas and hydrogen-containing gas. The first polymeric material may be a fully cured polymeric material. A second polymeric material may then be deposited on the plasma treated surface of the first polymeric material. The second polymeric material may be an uncured polymeric material. This plasma treatment may be used in improving the adhesion between polymeric components of an inkjet printer. It provides good adhesion between the polymeric components of the inkjet printer even after long exposure to ink.

### BACKGROUND

1. Field of the Disclosure

The disclosure generally relates to a method of improving adhesion between polymeric materials, and more particularly, to a method of improving adhesion between polymeric components of an inkjet printer.

2. Description of the Related Art

Polymeric material may be subjected to plasma treatment to improve its adhesion to other polymeric material and/or substrate. In the manufacture of inkjet printheads, polymeric flow features may be treated with plasma before laminating with a polymeric nozzle plate. An oxygen plasma treatment is usually applied to improve the adhesion of the polymeric flow feature to the polymeric nozzle plate of the inkjet printhead. However, upon exposure of this formed printhead to an ink, the adhesion of the flow feature to the nozzle plate decreases over time.

The oxygen plasma treatment is believed to add hydroxyl functional groups to the treated surface of the polymeric flow feature. These hydroxyl functional groups are believed to provide covalent bonding between the adhering surfaces. But an analysis, such as with X-ray photoelectron spectroscopy, shows that the oxygen plasma forms an undesirable high concentration of carbonyl functional groups on the top surface of the flow feature instead of a desirable high concentration of desirable hydroxyl functional groups. Adhesion is compromised by the presence of this high concentration of carbonyl functional groups.

The adhesion problem is even magnified on printheads with flow features having smaller surface area, and may adversely affect the print quality of the printhead. An adhesion promoter such as (g-glycidoxypropyltrimethoxy silane) may be provided on the flow feature to improve the adhesion of the nozzle plate, but this addition of (g-glycidoxypropyltrimethoxy silane) requires additional processing steps. Thus, there is a need for improving the existing plasma treatment process to generate desirable hydroxyl functional groups on the treated polymeric surface and improve the adhesion of the treated polymeric surface to other polymeric materials.

### SUMMARY

The present disclosure provides a method of improving adhesion between polymeric materials. The method includes treating a surface of a first polymeric material with plasma of oxygen gas and hydrogen-containing gas. The first polymeric material may be a fully cured polymeric material. A second polymeric material may then be deposited on the plasma treated surface of the first polymeric material. The second polymeric material may be an uncured polymeric material. The plasma treatment of the present invention forms desirable to hydroxyl functional groups on the surface of the first polymeric material. These desirable hydroxyl functional groups allow covalent bonding between the adhering surfaces of the first and second polymeric materials, thus providing better adhesion between the polymeric materials.

The plasma treatment of the present disclosure may be used in improving the adhesion between polymeric components of an inkjet printer. One example application is for improving the adhesion of a fully cured polymeric flow feature to an uncured polymeric nozzle plate of a printhead assembly of the inkjet printer. Another example application is for improving the adhesion of a polymeric printhead body of the inkjet printer to a liquid polymeric adhesive to allow attachment of further components. The plasma treatment provides good adhesion between the polymeric components of the inkjet printer even after long exposure to ink.

Features and advantages of the present disclosure will be more understood through the detailed description and in reference to the figures which follow.

### BRIEF DESCRIPTION OF THE DRAWINGS

FIG. 1 is a schematic flow diagram of a plasma treatment process.

FIG. 2 is a partial cross-sectional view of a printhead assembly with nozzle plate laminated to a flow feature treated with plasma according to one example embodiment.

FIGS. 3-4 are graphical views of adhesion test results showing the average shear force needed to shear off a nozzle plate from a flow feature.

FIG. 5 is a graphical view of adhesion test results showing the number of RFID tags being destroyed upon pulling off from a polypropylene substrate.

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the printhead of an inkjet printer set forth in the following description. The present disclosure is capable of other embodiments and of being used in to various applications. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

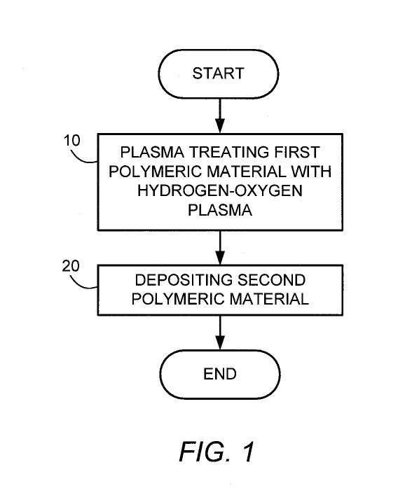

The present disclosure provides a method for improving adhesion of a first polymeric material to a second polymeric material. Referring to FIG. 1, the method includes treating an adhering surface of the first polymeric material with a hydrogen-oxygen plasma 10. The first polymeric material may include epoxy, polyether, polypropylene, polyethylene, bismaleimide, polyimide or polyamide. This first polymeric material is a fully cured or fully cross-linked polymer. In some example embodiments, the first polymeric material may include a fully cured epoxy material. In some other example embodiments the first polymeric material may include a polypropylene substrate.

The hydrogen-oxygen plasma may be generated by applying an electric field to a combination of oxygen gas and hydrogen or hydrogen-containing gas. The electric field may be formed from various sources such as direct current, alternating current, audio frequency, intermediate frequency, microwave frequency, etc. In some example embodiments the electric field may be formed from radio frequency.

The gases may be supplied at a mass flow ratio of oxygen gas to hydrogen or hydrogen-containing gas of about 3:1 to about 1:3. Preferably, the mass flow ratio of oxygen gas to hydrogen or hydrogen-containing gas may be about 1:1.

The hydrogen-containing gas may be water vapor or a hydrocarbon such as methane. In some example embodiments, the hydrogen-containing gas may be a forming gas. The forming gas is a non-combustible mixture of an inert gas and a reactive gas. It may comprise a major amount of the inert gas and a minor amount of the reactive gas. For purposes of this disclosure, a major amount is defined as greater than 50% by volume, and a minor amount is defined as less than 50% by volume, of the total forming gas volume. Suitable examples of forming gas may include nitrogen/hydrogen mixtures, argon/hydrogen mixtures, helium/hydrogen mixtures, and the like. Preferably, the forming gas may be a mixture of 95% by volume of nitrogen and 5% by volume of hydrogen.

The gas combination creates plasma with a reductive or less oxidative environment which suppressed the generation of carbonyl functional groups and increased production of hydroxyl functional groups on the surface of the treated first polymeric material. The hydroxyl functional groups allow covalent bonding between the adhering surfaces, thus providing better adhesion between the polymeric materials.

Referring to FIG. 1, the plasma-treated surface of the first polymeric material is then deposited with the second polymeric material 20. The second polymeric material may include epoxy, polyether, polypropylene, polyethylene, bismaleimide, polyimide or polyamide. This second polymeric material may be an uncured or a partially cured polymeric material such as a liquid polymeric adhesive. In some example embodiments, the second polymeric material may be an uncured polymeric dry film.

The second polymeric material may be deposited in various ways. The uncured polymeric dry film may be deposited to the plasma-treated first polymeric material by laminating under heat and pressure. The liquid polymeric adhesive may be deposited through jetting, spin coating, or by dipping into it the plasma-treated first polymeric material. The second polymeric material may then be cured after depositing on the plasma-treated first polymeric material.

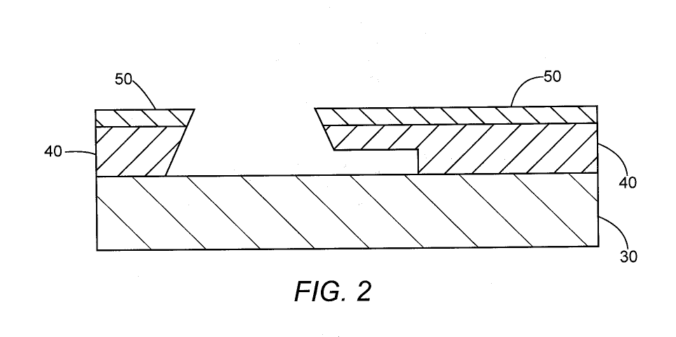

The plasma treatment of the present disclosure may be used in improving the adhesion between the polymeric components of an inkjet printer. One example application of the plasma treatment in this example embodiment is for improving the adhesion of a polymeric flow feature to a polymeric nozzle plate of a printhead assembly of the inkjet printer. Referring to FIG. 2, the printhead assembly of the inkjet printer generally includes a lower base such as a silicon substrate 30, an upper layer of flow feature 40 etched upon the silicon substrate 30, and the nozzle plate 50 disposed on the upper surface of the flow feature 40.

The polymeric flow feature 40 may be formed by spin coating a polymeric material such as a photosensitive epoxy material onto a silicon wafer. The photosensitive polymeric material may be spun or coated on the silicon wafer at about 2000 to about 3000 rpm for a time period of about 60 to about 90 seconds. The coated photosensitive polymeric material may be subsequently soft baked at a temperature of about 95° C. for a time period of about 1 to about 2 minutes, imaged in the range of about 1000 to about 3000 J/m², and post-exposure to baked at a temperature of about 95° C. for a time period of about 2 to about 5 minutes. The flow feature 40 may then be developed by puddling a developer solvent such as a propylene glycol monomethyl ether acetate (PGMEA) solvent onto the coated silicon wafer for about 15 to about 120 seconds, and spin drying. The formed flow feature 40 may be subsequently exposed to ultraviolet radiation of about 9 J, and baked at a temperature of about 200° C. for a time period of about 2 hours to completely cure.

In this example embodiment, the fully cured polymeric flow feature 40 may be treated with hydrogen-oxygen plasma for a time period of about 1 to about 5 minutes. The hydrogen-oxygen plasma may be generated by applying the electric field to the combination of oxygen gas and hydrogen-containing gas at a radio frequency power of about 100 to about 500 watts. The oxygen gas may be supplied at a flow rate of about 50 to about 150 standard cubic centimeters per minute (sccm). The hydrogen-containing gas may be supplied at a flow rate of about 20 to about 80 sccm.

The polymeric nozzle plate 50 may comprise the polymeric dry film such as a photosensitive epoxy dry film. This uncured polymeric dry film may be laminated to the plasma-treated polymeric flow feature 40 under the application of heat and pressure. In some example embodiments, the plasma-treated polymeric flow feature 40 may be treated with adhesion promoter such as a silane adhesion promoter before laminating with the polymeric nozzle plate 50.

To demonstrate how the adhesion of the polymeric flow feature 40 to the polymeric nozzle plate 50 improves with the plasma treatment in this example embodiment, the fully cured flow features are divided into four sample groups and applied with different plasma treatment conditions presented in Table 1.

TABLE 1

| | | | Radio Frequency | Treatment |
|---|---|---|---|---|
| | | Gas Flow Rate | Power | Time |
| Samples | Treatment Gas | (sccm) | (watts) | (minutes) |
| A | O₂/H₂O | 100/40 | 300 | 2 |
| B | O₂/forming gas | 70/30 | 300 | 1 |
| C1/C2 | O₂ | 100 | 150 | 1 |

Sample group A is treated with hydrogen-oxygen plasma for a time period of about 2 minutes. The hydrogen-oxygen plasma is generated from the combination of oxygen gas and water vapor being applied with electric field at a radio frequency power of about 300 watts. The oxygen gas is supplied at a flow rate of about 100 sccm. The water vapor is supplied at a flow rate of about 40 sccm.

Sample group B is treated with hydrogen-oxygen plasma for a time period of about 1 minute. The hydrogen-oxygen plasma is generated from the combination of oxygen gas and forming gas being applied with electric field at a radio frequency power of about 300 watts. The oxygen gas is supplied at a flow rate of about 70 sccm. The forming gas comprises 95% by volume of nitrogen and 5% by volume of hydrogen, and is supplied at a flow rate of about 30 sccm.

Sample groups C1 and C2 are treated with oxygen plasma for a time period of about 1 minute. The oxygen gas is supplied at a flow rate of about 100 sccm and applied with electric field at a radio frequency power of about 150 watts. These sample groups C1 and C2 are used as the control group or as basis of comparison to sample groups A and B respectively.

All the plasma-treated samples are further treated with 1% glycidoxy silane solution for 1 minute. The uncured polymeric nozzle plates are then laminated to the treated samples at a temperature of about 40 to about 80° C. and a pressure of about 5 to 40 psi. Flow feature/nozzle plate assemblies are then obtained from sample groups A, B, C1 and C2.

An adhesion test is then conducted using a shear tester, Dage Series 4000. The force needed to shear off the nozzle plate from the flow feature is measured before and after exposure of the formed flow feature/nozzle plate assemblies to ink at a temperature of 60° C. for a period of 1, 4 and 10 weeks. The larger the average shear force required to shear off the nozzle plate from the flow feature, the better is the adhesion.

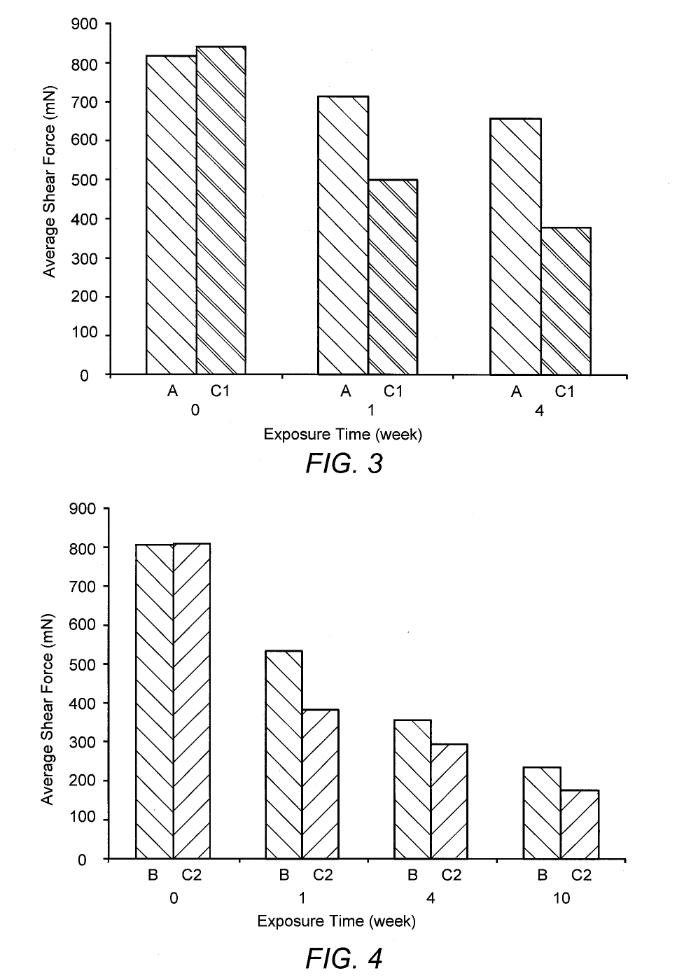

FIG. 3 graphically shows the average shear force measured on flow feature/nozzle plate assemblies of sample group A in comparison with the average shear force measured on flow feature/nozzle plate assemblies of the control group C1. The adhesion of the flow feature to the nozzle plate of sample group A and control group C1 are good prior to ink soak. After exposure to ink for 1 and 4 weeks, a large loss of adhesion is observed with the control group C1. Flow feature samples that are treated with the plasma of oxygen gas and water vapor retain better adhesion to the nozzle plate even after exposure to ink for 4 weeks, as compared to flow feature samples treated with the plasma of oxygen gas.

FIG. 4 graphically shows the average shear force measured on flow feature/nozzle plate assemblies of sample group B in comparison with the average shear force measured on flow feature/nozzle plate assemblies of control group C2. The adhesion of the flow feature to the nozzle plate of sample groups B and control group C2 are good prior to ink soak. After exposure to ink for 1, 4, and 10 weeks, a loss of adhesion is observed with sample group B and control group C2. Control group C2 has a greater loss of adhesion compared to sample group B. The flow feature samples that are treated with the plasma of oxygen gas and forming gas retain better adhesion to the nozzle plate even after exposure to ink for 10 weeks, as compared to the flow feature samples treated with the plasma of oxygen gas.

Another example application of the plasma treatment in this example embodiment is for improving the adhesion of a polymeric printhead body of the inkjet printer to liquid polymeric adhesive which allow attachment of further components. The polymeric printhead body may comprise the polypropylene substrate. The liquid polymeric adhesive may comprise an epoxy adhesive.

In this example embodiment, the polymeric printhead body may be treated with hydrogen-oxygen plasma for a time period of about 1 to about 5 minutes. The hydrogen-oxygen plasma may be generated by applying the electric field to the combination of oxygen gas and hydrogen-containing gas at a radio frequency power of about 150 to about 400 watts. The oxygen gas may be supplied at a flow rate of about 30 to about 70 sccm. The hydrogen-containing gas may be supplied at a flow rate of about 30 to about 70 sccm.

The plasma-treated polymeric printhead body may be disposed with the liquid polymeric adhesive. Further components may be attached to the printhead body through the liquid polymeric adhesive. This additional component may comprise polymeric materials. Example of this additional component includes an RFID tag. In some example embodiment, the additional component may be treated with hydrogen-oxygen plasma before attaching on the disposed liquid polymeric adhesive. The disposed liquid polymeric adhesive may then be cured after attaching the additional component.

To demonstrate how the adhesion of the polymeric printhead body to the liquid polymeric adhesive improves with the plasma treatment in this example embodiment, four groups of polypropylene substrates are applied with the different plasma treatment conditions presented in Table 2.

TABLE 2

| | | | Radio Frequency | Treatment |
|---|---|---|---|---|
| | | Gas Flow Rate | Power | Time |
| Samples | Treatment Gas | (sccm) | (watts) | (minutes) |
| A1 | O₂/H₂O | 50/50 | 150 | 3 |
| B1 | O₂/forming gas | 50/50 | 300 | 1 |
| B2 | O₂/forming gas | 50/50 | 300 | 3 |
| C3 | O₂ | 100 | 300 | 3 |

The polypropylene substrates of sample group A1 are treated with hydrogen-oxygen plasma for a time period of about 3 minutes. The hydrogen-oxygen plasma is generated from the combination of oxygen gas and water vapor being applied with electric field at a radio frequency power of about 150 watts. The oxygen gas is supplied at a flow rate of about 50 sccm. The water vapor is supplied at a flow rate of about 50 sccm.

The polypropylene substrates of sample groups B1 and B2 are treated with hydrogen-oxygen plasma for a time period of about 1 minute and about 3 minutes respectively. The hydrogen-oxygen plasma is generated from the combination of oxygen gas and forming gas being applied with electric field at a radio frequency power of about 300 watts. The oxygen gas is supplied at a flow rate of about 50 sccm. The forming gas comprises 95% by volume of nitrogen and 5% by volume of hydrogen, and is supplied at a flow rate of about 50 sccm.

The polypropylene substrates of sample group C3 are treated with oxygen plasma for a time period of about 3 minutes. The oxygen gas is supplied at a flow rate of about 100 sccm and applied with electric field at a radio frequency power of about 300 watts. This sample group C3 is used as the control group or as basis of comparison to sample groups A1, B1 and B2.

The plasma-treated polypropylene substrates of sample groups A1, B1 and B2, and control group C3 are subsequently disposed with liquid epoxy adhesives and attached with the RFID tag. The liquid epoxy adhesive is then cured for 24 hours after attaching the RFID tag.

The adhesion test is then conducted by pulling off the attached RFID tag from the polypropylene substrate. The adhesion is rated to be good if the RFID tag has been destroyed upon pulling off from the polypropylene substrate. The adhesion is rated to be poor if the RFID tag has been pulled off undamaged from the polypropylene substrate. Twelve samples from each sample groups are further exposed to a temperature of 60° C. and relative humidity of 100% for a time period of 1, 4, and 8 weeks before conducting the adhesion test.

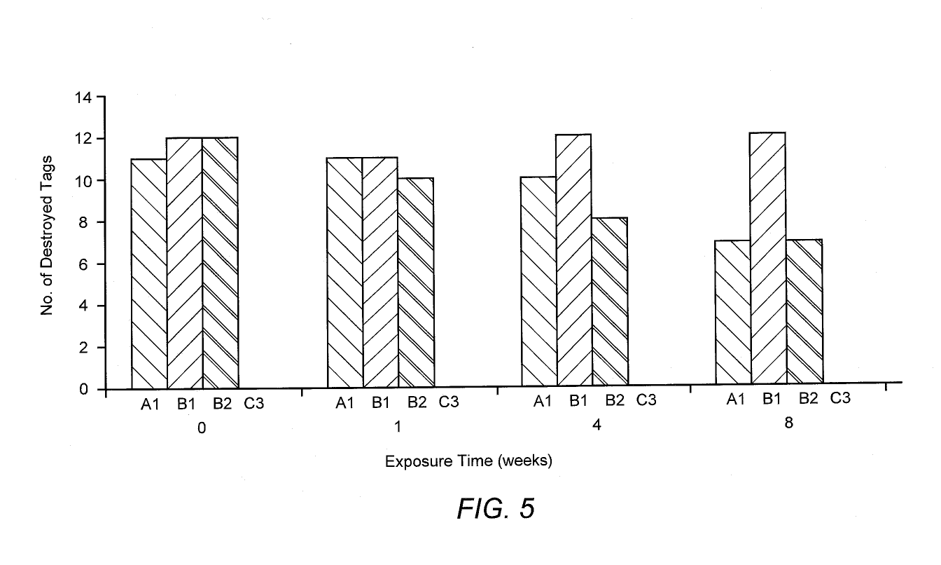

FIG. 5 graphically shows the number of RFID tags that are destroyed upon pulling off from the polypropylene substrate before and after exposure to a temperature of 60° C. and relative humidity of 100% for a time period of 1, 4 and 8 weeks. All the RFID tags of the control group C3 are pulled off undamaged indicating the poor adhesion of the polypropylene substrate to the epoxy adhesive. Several RFID tags of sample groups A1, B1 and B2 are damaged upon pulling off from the polypropylene substrate indicating the good adhesion of the polypropylene substrate to the epoxy adhesive. The polypropylene substrate treated with hydrogen-oxygen plasma has good adhesion to the epoxy adhesive even after exposure to the temperature of 60° C. and relative humidity of 100% for a time period of 8 weeks.

The foregoing description of several embodiments and methods of the present disclosure have been presented for purposes of illustration. It is not intended to be exhaustive or to limit the present disclosure to the precise steps and/or forms disclosed, and obviously many modifications and variations are possible in light of the above teaching. It is intended that the scope of the present disclosure be defined by the claims appended hereto.

What is claimed is:

1. A method for improving adhesion between polymeric materials comprising:
treating a surface of a first polymeric material with a plasma of oxygen gas and hydrogen-containing gas; and
depositing a second polymeric material on the plasma-treated surface of the first polymeric material.

2. The method of claim 1, wherein the first and second polymeric materials are selected from the group comprising of epoxy, polyether, polypropylene, polyethylene, bismaleimides, polyimide or polyamides.

3. The method of claim 1, wherein the first polymeric material comprises a fully cured polymeric material.

4. The method of claim 1, wherein the second polymeric material comprises an uncured polymeric material.

5. The method of claim 4, wherein the second polymeric material comprises a liquid polymeric adhesive.

6. The method of claim 4, wherein the second polymeric material comprises an uncured polymeric dry film.

7. The method of claim 1, wherein the hydrogen-containing gas comprises forming gas, water vapor, or methane.

8. The method of claim 7, wherein the forming gas comprises inert gas and hydrogen gas.

9. The method of claim 1, further comprising supplying oxygen gas and hydrogen-containing gas at a mass flow ratio of about 3:1 to about 1:3.

10. A method for improving adhesion of a polymeric flow feature to a polymeric nozzle plate of a printhead assembly, comprising:
treating a surface of a fully cured polymeric flow feature with a plasma of oxygen gas and hydrogen-containing gas; and
laminating an uncured polymeric nozzle plate on the plasma-treated surface of the fully cured polymeric flow feature.

11. The method of claim 10, further including treating the plasma-treated surface of the fully cured polymeric flow feature with silane adhesion promoter before laminating the uncured polymeric nozzle plate.

12. The method of claim 10, wherein the hydrogen-containing gas is water vapor.

13. The method of claim 10, wherein the hydrogen-containing gas is forming gas comprising nitrogen and hydrogen.

14. A method for improving adhesion of a fully cured polymeric substrate to a liquid polymeric adhesive, comprising:
treating a surface of the fully cured polymeric substrate with a plasma of oxygen gas and hydrogen-containing gas;
depositing the liquid polymeric adhesive to the plasma-treated surface of the fully cured polymeric substrate; and
curing the liquid adhesive.

15. The method of claim 14, wherein the fully cured polymeric substrate comprises polypropylene substrate.

16. The method of claim 14, wherein the liquid polymeric adhesive comprises liquid epoxy adhesive.

17. The method of claim 14, further including attaching another polymeric substrate on the deposited liquid adhesive prior to curing.
